(19) United States
(12) Patent Application Publication
(10) Pub. No.: US 2007/0034042 A1
(43) Pub. Date: Feb. 15, 2007

(54) Rotational movement generating and amplifying apparatus

(76) Inventor: Dug Gum Lee, Los Angeles, CA (US)

Correspondence Address: Jerry H. Noh, Suite 2741, 3435 Wilshire Blvd., Los Angeles, CA, 90010, US

(21) Appl. No.: 11/200,276

(22) Filed: Aug. 9, 2005

(51) Int. Cl. H02K 7/02

(52) U.S. Cl. 74/572.1

(57) ABSTRACT

A rotational movement generating and amplifying apparatus comprising a first disk of a first radius; a rotating first rod protruding upward from the first disk; and a rotational assembly having a first elongated plate member, second elongated plate member, and second disk. The first plate member connecting to the first rod. The second disk of a second radius, being adjacent to the first disk. The second disk having a rotating second rod protruding upwards therefrom. The second rod extending through the first plate member and connecting to the second elongated plate member. The second plate member having an attachment point located a predetermined distance away from the axis of the first disk of at least double the distance of the sum of the first and second radius. The axis of the second disk not being coplanar with the axis of the first disk and the attachment point. The apparatus being constructed so that a predetermined force pulling the second elongated plate member at the attachment point towards the axis of the first disk causes the second disk to circle around the first disk.

### BACKGROUND OF THE INVENTION

1. Field of the Invention

This invention generally relates to an apparatus for generating a rotating motion movement of most rotating devices. More particularly the apparatus of the present invention relates to an apparatus which generates a constant rotating motion, which can be used for amplifying the rotational movement of rotating devices including windmills, wheels, propellers, axle of wheels, and gears.

2. Description of the Prior Art

There are many different types of rotating devices. Examples of rotating devices include windmills, wheels, propellers, axle for wheels, motor gears, and so on. For windmills, the power to turn the blades of the windmill comes from wind hitting the blades at the proper angle. The wind must continually blow onto the blades to continue the rotation of the blades. For wheels, examples include from bicycle wheels, motorcycle wheels, to ferris wheels. For bicycles, power for rotation of the wheels derives from manual leg power pushing the pedals, and for motorcycles and ferris wheels, power for rotation comes from battery or electric powered motors.

For generating rotational force for rotating devices, power must come from sources such as manual, leg powered, battery, electric, wind, solar, and so on. It is desirable that the least amount of power from the power source be used for generation of the rotation of the rotating device. There are known ways to lower the amount of power utilized from the power source, which can include modification of the design of the rotating device, varying the weight of the rotating devices, and varying the structure of the rotating device. In a U.S. Pat. No. 3,885,814 issued to Rizzo, a bicycle is taught having a wheel specially weighted with weights which are slidably attached to the spokes of the wheel and are spring biased to move between an extended and a retracted position depending on the rate of rotation of the wheel. These weights are placed on the wheel to afford enhanced momentum, stability, and reduce human pedal power for continual rotation at high rates of speed.

None of the prior art teaches an apparatus as taught by the present invention. The apparatus of the present invention generates rotational force utilizing a constant eccentric force pulling one disk against another. The apparatus of the present invention can be. used to generate a constant rotating motion using an eccentric pulling force. The apparatus can be coupled with rotating devices to reduce the power necessary to rotate the rotating portions of these rotating devices.

Thus, it is an object of the present invention to provide an apparatus which generates a constant rotational force with the application of a constant pulling force. It is another object of the present invention to provide an apparatus which provides amplification of rotational force to rotating devices. It is yet another object of the present invention to reduce the usage of power necessary to rotate devices.

### SUMMARY OF THE INVENTION

The present invention is an apparatus for generating a rotational movement using eccentric force. The rotational generated can be used for amplifying the rotational movement of miscellaneous rotating objects. The apparatus comprises a first disk having a first radius. The first disk has a first center and a rotating first rod protruding upward from the first center. A rotational assembly connects to the first disk for generating a rotation of the first rod. The rotational assembly has a first elongated plate member, second elongated plate member, and second disk. The first plate member connects to the first rod and extends radially therefrom. The first plate member has a first slot formed therethrough. A second disk having a second radius is placed adjacent to the first disk, and the second disk has a second center and a rotating second rod protruding upwards from the second center. The second rod extends through the first slot and connects to the second elongated plate member. The second plate member has an attachment point with an attachment member protruding from the attachment point. The attachment member is parallel to the axis of the first disk. The attachment point should be located a predetermined distance away from the axis of the first disk of at least double the distance of the sum of the first radius and second radius. In addition, the axis of the first disk and the attachment point should be coplanar, and the axis of the second disk should not be coplanar with the axis of the first disk and the attachment point.

A pin extends upwards from the first plate member, and through a slot formed through the second plate member. The apparatus is constructed so that a predetermined force pulling the second elongated plate member at the attachment point or at the attachment member towards the axis of the first disk presses the second disk against the first disk and generates a rotation of the second disk circling around the circumference of the first disk. Additionally, a constant application of such a predetermined force pulling the second elongated plate member at the attachment point or at the attachment member will cause the second disk to continuously rotate and circle around the first disk, thereby continuously rotating the first rod. The source of the pulling force can be connected to the first rod, connected to a housing for the apparatus, or a source not connected to the apparatus.

The present invention can be coupled with most devices, which have a rotational movement for enhancement of the rotational force of the rotating component.

### BRIEF DESCRIPTION OF THE DRAWINGS

FIG. 1 is a top perspective view of the present invention;

FIG. 2 is a side elevational view of the present invention;

FIG. 3 is a top plan view of the present invention;

FIG. 4 is a top plan view of the present invention shown with the first elongated plate member and second elongated plate member removed;

FIG. 5 is a side elevational view of an illustration of the present invention in use with a type of predetermined pulling force; and,

FIG. 6 is a side elevational view of an illustration of the present invention in use with another type of predetermined pulling force.

### DETAILED DESCRIPTION OF THE PREFERRED EMBODIMENT

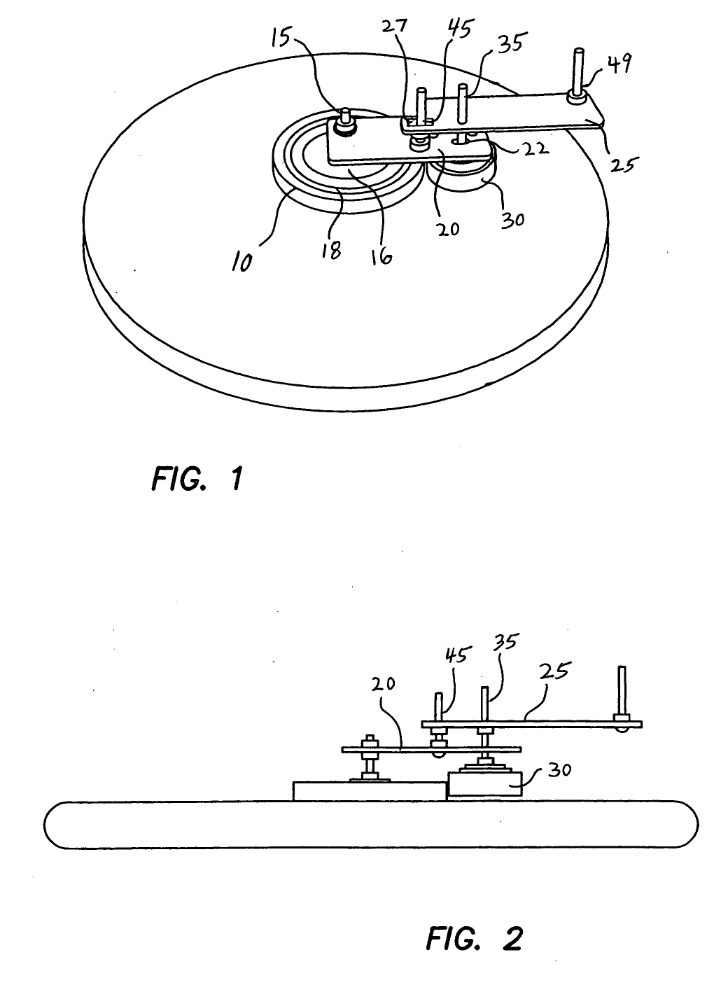

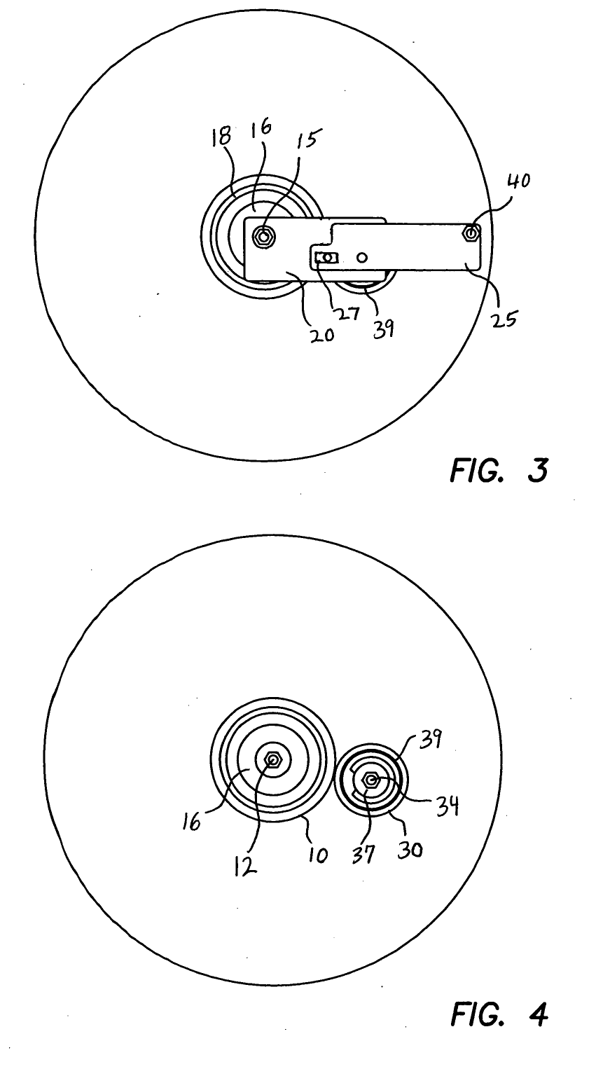

The present invention illustrated in FIGS. 1 to 6 is an apparatus which utilizes eccentric force to generate a rotating motion. Such rotating motion can be used to0 amplify the rotational movement of miscellaneous rotating objects. The apparatus comprises a first disk 10 having a first center 12. A first rod 15 protrudes upward from the first center 12. The length of the first rod 15 is not a limiting factor. The first disk 10 is constructed to allow the first rod 15 to rotate. The first rod 15 itself can be constructed to rotate within the first disk 10, or in the alternative, the first rod 15 can be attached to another portion of the first disk 10, which rotates within the first disk 10. In the embodiment shown in FIGS. 1 to 6, the first rod 15 protrudes from an inner disk portion 16 of the first disk 15 that rotates within the first disk 10, and the inner disk portion 16 has a layer of bearing 18 encircling the outer circumference to allow the inner disk portion 16 to rotate smoothly within the first disk 10.

A rotational assembly connects to the first disk for generating a rotation of the first rod 15. The rotational assembly includes a first elongated plate member 20, second elongated plate member 25, and second disk 30. The first elongated plate member 20 connects to the first rod 15 and extends radially from the first rod 15. The first plate member 20 has a first slot 22 formed therethrough. The second disk 30 is placed adjacent to the first disk 10. The second disk 30 has a second center 34 and a second rod 35. The second rod 35 protrudes upwards from the second center 34, and the second disk 30 is constructed to allow the second rod 35 to rotate. The second rod 35 itself can be constructed to rotate within the second disk 30, or in the alternative, the second rod 35 can be attached to another portion of the second disk 30, which rotates within the second disk 30. In the embodiment shown in FIGS. 1 to 6, the second rod 35 protrudes from an inner disk portion 37 of the second disk 30 that rotates within the second disk, and the inner disk portion 37 has a layer of bearing 39 encircling the outer circumference to allow the inner disk portion 37 to rotate smoothly within the second disk 30. The second rod 35 extends through the first slot 22 and connects to the second plate member 25 positioned above the first plate member 20.

The second plate member 25 has an attachment point 40. The attachment point 40 is located further away from the first center 12 than the second center 34 is away from the first center 12. The first disk 10 has a first radius, and the second disk 30 has a second radius. The attachment point 40 should be located a predetermined distance away from the axis of the first disk 10 of at least double the distance of the sum of the first radius and second radius. In addition, the axis of the first disk 10 and the attachment point 40 should be coplanar, and the axis of the second disk 30 should not be coplanar with the axis of the first disk 10 and the attachment point 40.

Also, as shown in FIGS. 1 to 3, a pin 45 extends upwards from the first plate member 20, and through a slot 27 formed through the second plate member 25. In the embodiment shown, the pin 45 is positioned so that an imaginary line extending from the pin 45 to the second rod 35 is parallel to an imaginary line extending from the first rod 15 to the attachment point 40. Also, in the embodiment shown, the direction of the first slot 22 and the slot 27 formed on the second plate member 25 is parallel to an imaginary line extending from the first rod 15 to the attachment point 40.

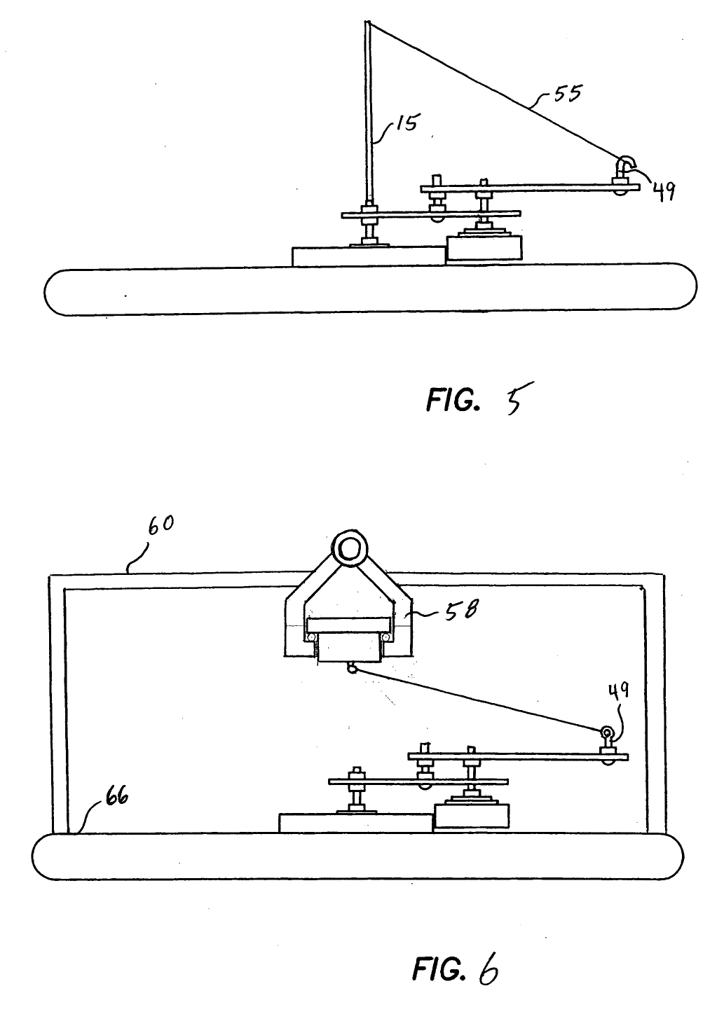

A predetermined force pulling the second plate member 25 at the attachment point 40 towards the axis of the first disk 10 presses the second disk 30 against the first disk 10 and generates a rotation of the second disk 30 circling around the circumference of the first disk 10. That is, the second disk 30 rotates as it circles around the circumference of the first disk 10. The predetermined force pulling the second plate member 25 creates an eccentric force between the first disk 10 and second disk 30. The movement of the second disk 30 is in conjunction with the rotation of the first plate member 20, which in turn rotates the first rod 15. An attachment member 49 can be formed at the attachment point 40 to allow for connection to a predetermined force pulling the second plate member 25. The attachment member 49 can be a hole (not shown) formed through the second plate member 25 at the attachment point 40. Or in the alternative, the attachment member 49 can be a miscellaneous item including but not limited to a hook (as shown in FIG. 5), loop, or ring (as shown in FIG. 6). In the embodiment shown, the attachment member 49 is a bar protruding from the attachment point 40. The attachment member 49 is parallel to the axis of the first disk 10. The attachment member 49 should be separated a predetermined distance away from the axis of the first disk 10 of at least double the distance of the sum of the first radius and second radius. A predetermined force pulling the second elongated plate member 25 at the attachment member 49 towards the axis of the first disk 10 will also press the second disk 30 against the first disk 10 and generate a rotation of the second disk 30 circling around the circumference of the first disk 10.

In the embodiment shown FIGS. 1 to 6, the first disk 10 and second disk 30 each has a smooth outer surface. In the alternative, a first disk 10 and second disk 30 each with a toothed outer surface in the form of a gear (not shown) can be utilized.

In use, the constant application of a predetermined force pulling the second plate member 25 at the attachment point or at the attachment member 49 will cause the second disk 30 to continuously rotate and circle around the first disk 10, thereby continuously rotating the first rod 15. The source of the predetermined force pulling the second plate member 25 is not a limiting factor. There are many sources of such a pulling force known in the art, including but not limited to elastic bands, springs, thrust ball bearings, and tension bars. The source of the pulling force can be connected to the first rod 15, connected to a housing for the apparatus, or not connected to the apparatus at all. For purposes of illustration, FIGS. 5 and 6 illustrate both illustrate one of many possible sources of the predetermined pulling force. FIG. 5 shows an elongated first rod 15, and an elastic band 55 connecting the first rod 15 to the attachment member 49. The elastic band 55 is in a stretched state so that it is biased to urge the attachment member 49 toward the first rod 15. In FIG. 6, a thrust ball bearing structure 58 is positioned on a support structure 60 forming part of a housing 66 for the apparatus. The thrust ball bearing structure 58 is positioned in line with the axis of the first disk 10 and has the same axis of rotation as the axis of the first disk 10.

The present invention can be coupled with most devices, which have a rotational movement for enhancement of the rotational force of the rotating component. Although not shown in the illustrations, the apparatus can be coupled to the rotating blade of a windmill and countless number of other rotating devices in order to provide amplification of the rotating movement. For instance, other rotating devices can include, wheels, mills, propellers, mills, gears, and others. Although the embodiment shown in the illustrations show one rotational assembly attached to the first rod, multiple rotational assemblies can be attached to the first rod to further enhance the amplification of the rotational force of the first rod.

Although an embodiment of the invention has been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claims which follow.

What is claimed as being new and therefore desired to be protected by letters patent of the United States is as follows:

1. A rotational movement apparatus comprising:
a first disk, said first disk having a first center;
a first rod protruding upward from the first center, said first disk constructed so that said first rod rotates;
a first elongated plate member connected to said first rod, said first plate member extending radially from said first rod, a first slot formed through said first plate member;
a second disk disposed adjacent said first disk, said second disk having a second center, a second rod protruding upward from the second center, said second disk constructed so that said second rod can rotate, said second rod extending through said first slot;
a second elongated plate member disposed above said first plate member, said second rod connecting to said second elongated plate member;
an attachment point disposed on said second plate; and
wherein said attachment point is a predetermined position on said second elongated plate member such that when a predetermined force pulls the second elongated plate member at the attachment point towards the first center, the second disk presses against the first disk causing the second disk to circle around the circumference of the first disk.

2. The apparatus as described in claim 1 wherein:
said first disk has a first radius;
said second disk has a second radius;
and said attachment point is located a predetermined distance away from the axis of the first disk of at least double the distance of the sum of the first radius and second radius.

3. The apparatus as described in claim 2 wherein: the axis of the first disk and attachment point are coplanar, and the axis of the second disk is not coplanar with the axis of the first disk and attachment point.

4. The apparatus as described in claim 1 comprising an attachment member protruding from the attachment point; and wherein a predetermined force pulling the second elongated plate member at said attachment member towards the first center will press the second disk against the first disk causing the second disk to circle around the circumference of the first disk.

5. The apparatus as described in claim 4 wherein: the axis of the first disk and attachment point are coplanar, and the axis of the second disk is not coplanar with the axis of the first disk and attachment point.

6. The apparatus as described in claim 4 wherein said attachment member is parallel to said axis of the first disk.

7. The apparatus as described in claim 6 wherein: the axis of the first disk and attachment point are coplanar, and the axis of the second disk is not coplanar with the axis of the first disk and attachment point.

8. A rotational movement apparatus comprising:
a first disk, said first disk having a first center;
a first rod protruding upward from the first center, said first disk constructed so that said first rod can rotate;
a first elongated plate member connected to said first rod, said first plate member extending radially from said first rod, a first slot formed through said first plate member;
a second disk disposed adjacent said first disk, said second disk having a second center, a second rod protruding upward from the second center, said second disk constructed so that said second rod can rotate, said second rod extending through said first slot;
a second elongated plate member disposed above said first plate member, said second rod connecting to said second elongated plate member;
an attachment point disposed on said second plate;
said first disk having a first radius;
said second disk having a second radius;
said attachment point being located a predetermined distance away from the axis of the first disk of at least double the distance of the sum of the first radius and second radius;
said axis of the first disk and attachment point being coplanar;
the axis of the second disk not being coplanar with the axis of the first disk and attachment point; and,
wherein a predetermined force pulling the second elongated plate member at the attachment point towards the axis of the first disk presses the second disk against the first disk causing the second disk to circle around the circumference of the first disk.

9. The apparatus as described in claim 8 comprising an attachment member protruding from the attachment point; and wherein a predetermined force pulling the second elongated plate member at said attachment member towards the axis of the first disk will press the second disk against the first disk and cause the second disk to circle around the circumference of the first disk.

10. The apparatus as described in claim 9 wherein said attachment member is parallel to said axis of the first disk.
